(19) United States
(12) Patent Application Publication
(10) Pub. No.: US 2018/0100123 A1
(43) Pub. Date: Apr. 12, 2018

(54) CLEANING SOLUTION

(71) Applicant: Mectra Labs, Inc., Bloomfield, IN (US)

(72) Inventors: Alan Thomas Barker, Bloomington, IN (US); Lorena E. Terhune, Switz City, IN (US)

(21) Appl. No.: 15/729,192

(22) Filed: Oct. 10, 2017

Related U.S. Application Data
(60) Provisional application No. 62/407,059, filed on Oct. 12, 2016.

(51) Int. Cl. C11D 3/20; C11D 11/00; C11D 1/83; C11D 1/12; B08B 3/08

(52) U.S. Cl. CPC C11D 3/2082; C11D 11/0023; C11D 3/2096; C11D 1/72; C11D 1/12; B08B 3/08; C11D 1/83

(57) ABSTRACT

A cleaning solution includes an acid and a surfactant blend. The cleaning solution can be used to clean a surface of a device.

### CROSS REFERENCE TO RELATED APPLICATIONS

This application claims the benefit of and priority to U.S. Provisional Patent Application No. 62/407,059, filed 12 Oct. 2016, the disclosure of which is now incorporated herein by reference.

### FIELD OF THE DISCLOSURE

The present disclosure relates generally to cleaning solutions and more specifically to cleaning solutions for surfaces.

### BACKGROUND

Surgical processes often use electro-cautery probes for cutting and/or cauterizing tissue. Such electro-cautery probes, sometimes referred to as tips, are typically coated with a lubricant, such as Electro-Lube®, prior to and throughout the use of the electro-cautery probes to reduce charring. While the lubricant may reduce the char, a layer of char may build up on the cutting surface of the electro-cautery probe and lead to decreased performance. Removing the layer of char, sometimes called eschar, can be difficult and require harsh conditions that may decrease the performance of the electro-cautery equipment.

### SUMMARY

The present disclosure may comprise one or more of the following features and combinations thereof.

A cleaning solution may include an organic acid and a surfactant blend. In some embodiments, the organic acid comprises a compound of the formula

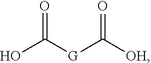

or a salt thereof, wherein G may be selected from the group consisting of a bond, C₁₋₁₀ alkylene, C₂₋₁₀ alkenylene, C₂₋₁₀ alkynylene, C₁₋₁₀ heteroalkylene, C₂₋₁₀ heteroalkenylene, and C₂₋₁₀ heteroalkynylene, and wherein each hydrogen atom in C₁₋₁₀ alkylene, C₂₋₁₀ alkenylene, C₂₋₁₀ alkynylene, C₁₋₁₀ heteroalkylene, C₂₋₁₀ heteroalkenylene, and C₂₋₁₀ heteroalkynylene may be optionally substituted with one or more R^{N}, wherein each R^{N} is independently selected from the group consisting of—halo, oxo, —OH, —CN, —NO₂, —CF₃, —OCF₃, —CO₂H, and —NH₂. In some embodiments G is a bond. In some other embodiments, G may be —CH₂C(OH)(CO₂H)CH₂—.

In some embodiments, the organic acid may be up to about 15% by weight of the cleaning solution. In other embodiments, the organic acid may be up to about 10% by weight of the cleaning solution. In yet another embodiment, the organic acid may be about 0.5% to about 15% by weight of the cleaning solution. In some embodiments, the organic acid may be about 0.5% to about 10% by weight of the cleaning solution. In some embodiments, the organic acid may be about 0.5% to about 5% by weight of the cleaning solution.

In some embodiments, the surfactant blend may comprise a primary surfactant and a first co-surfactant. In some embodiments, the surfactant blend may comprise a primary surfactant, a first co-surfactant, and a second co-surfactant. In some embodiments, the surfactant blend may comprise an emulsifier.

In some embodiments, the primary surfactant may be about 0.2% to about 20% by weight of the cleaning solution. In some embodiments, the primary surfactant may be about 0.1% to about 10% by weight of the cleaning solution. In some embodiments, the first surfactant may be about 0.5% to about 5% by weight of the cleaning solution. In some embodiments, the primary surfactant may be about 0.1% to about 10% by weight of the cleaning solution.

In some embodiments, the primary surfactant may comprise a compound having the formula

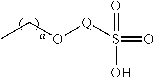

or a salt thereof, wherein a is an integer from 1-20, and Q is a bond or —C(O)CH₂—. In some embodiments, a may be 11 and Q may be a bond. In some embodiments, a may be 11 and Q may be —C(O)CH₂—.

In some embodiments, the cleaning solution may comprise a first co-surfactant. In some embodiments, the first co-surfactant may be up to about 10% by weight of the cleaning solution. In some embodiments, the first co-surfactant may be about 0.1% to about 10% by weight of the cleaning solution. In some embodiments, the first co-surfactant may be about 0.1% to about 3% by weight of the cleaning solution. In some embodiments, the first co-surfactant may be about 0.2% to about 1% by weight of the cleaning solution.

In some embodiments, the first co-surfactant may comprise a compound having the formula

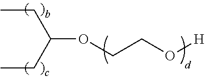

or a salt thereof, wherein each of b and c may be independently an integer from 0 to 12, and d may be an integer from 3 to 40. In some embodiments, d may be 7 or 9. In some embodiments, the sum of b+c may be 8 to 14.

In some embodiments, the cleaning solution may further comprise a second co-surfactant. In some embodiments, the second co-surfactant may be up to about 10% by weight of the cleaning solution. In some embodiments, the second co-surfactant may be about 0.1% to about 10% by weight of the cleaning solution. In some embodiments, the second co-surfactant may be about 0.1% to about 3% by weight of the cleaning solution. In some embodiments, the second co-surfactant may be about 0.2% to about 1% by weight of the cleaning solution.

In some embodiments, the second co-surfactant may comprise a compound of the formula

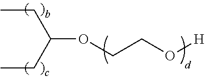

or a salt thereof, wherein each of b and c may be independently an integer from 0 to 12, and d may be an integer from 3 to 40. In some embodiments, d may be 3 and the sum of b+c may be 8 to 14.

In some embodiments, the surfactant blend may comprise an emulsifier comprising a compound having the formula

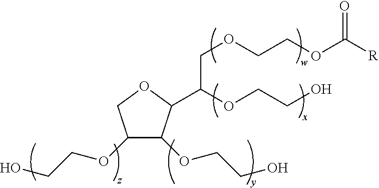

or a salt thereof, wherein w, x, y, and z may be respectively an integer from 1-20, the sum of w, x, y, and z is a multiple of 20; and R is selected from the group consisting of C₁₀₋₂₀ alkyl, C₁₋₁₀ alkyl, C₁₀₋₂₀ alkenyl, C₂₋₁₀ alkenyl, C₁₀₋₂₀ alkynyl, C₂₋₁₀ alkynyl, C₁₀₋₂₀ heteroalkyl, C₁₋₁₀ heteroalkyl, C₁₀₋₂₀ heteroalkenyl, C₂₋₁₀ heteroalkenyl, C₁₀₋₂₀ heteroalkynyl, and C₂₋₁₀ heteroalkynyl, and wherein each hydrogen atom in C₁₀₋₂₀ alkyl, C₁₋₁₀ alkyl, C₁₀₋₂₀ alkenyl, C₂₋₁₀ alkenyl, C₁₀₋₂₀ alkynyl, C₂₋₁₀ alkynyl, C₁₀₋₂₀ heteroalkyl, C₁₋₁₀ heteroalkyl, C₁₀₋₂₀ heteroalkenyl, C₂₋₁₀ heteroalkenyl, C₁₀₋₂₀ heteroalkynyl, and C₂₋₁₀ heteroalkynyl may be optionally substituted with one or more R^{M}, and wherein each R^{M} is independently selected from the group consisting of—halo, oxo, —OH, —CN, —NO₂, —CF₃, —OCF₃, —CO₂H, and —NH₂. In some embodiments, the sum of w, x, y, and z may be 20 and R may be C₁₀₋₂₀ alkyl. In some embodiments, the sum of w, x, y, and z may be 20 and R may be C₁₀₋₂₀ alkenyl. In some embodiments, the sum of w, x, y, and z may be 20 and R is —(CH₂)₇CH═CH(CH₂)₇CH₃.

In some embodiments, the cleaning solution may comprise an emulsifier. In some embodiments, the emulsifier may be up to about 10% by weight of the cleaning solution. In some embodiments, the emulsifier may be about 0.1% to about 10% by weight of the cleaning solution. In some embodiments, the emulsifier may be about 0.1% to about 3% by weight of the cleaning solution. In some embodiments, the emulsifier may be about 0.2% to about 1% by weight of the cleaning solution.

In some embodiments, the cleaning solution may comprise a thickening agent. In some embodiments, the cleaning solution may have a viscosity of at least 40,000 cps.

In another aspect in accordance with the present invention, a cleaning solution may comprise an organic acid and a surfactant blend. The surfactant blend may comprise a primary surfactant having a Hydrophile-Lipophile Balance (HLB) of at least about 15. The surfactant blend may comprise a first co-surfactant having an HLB selected from a range of about 12 to about 16. The surfactant blend may comprise a second co-surfactant having an HLB selected from a range of about 6 to about 10. The surfactant blend may comprise an emulsifier. In some embodiments, the HLB of the primary surfactant may be in a range of about 20 to about 45.

In some embodiments, the cleaning solution may comprise a passivation solution. In some embodiments, the passivation solution may be about 0.1% to about 15% by weight of the cleaning solution. In some embodiments, the passivation solution may be about 1% to about 10% by weight of the cleaning solution. In some embodiments, the passivation solution may comprise a peroxide. In some embodiments, the peroxide may be H₂O₂.

In some embodiments, the passivation solution may be about 2% to about 6% by weight of the cleaning solution. In some embodiments, the passivation solution may comprise ascorbic acid. In some embodiments, the passivation solution may further comprise H₂O₂. In some embodiments, the H₂O₂ may be about 0.5% to about 4% by weight of the cleaning solution. In some embodiments, the ascorbic acid and the H₂O₂ may be present in about a 5:1 molar ratio. In some embodiments, the ascorbic acid and the H₂O₂ may be present in about a 10:1 molar ratio.

According to another aspect of the present disclosure, a method for cleaning a surface of a device may include contacting a surface with a cleaning solution, wherein the cleaning solution may comprise an organic acid and a surfactant blend. In some embodiments, the device may be a medical device. In some embodiments, the medical device may be cutting device. In some embodiments, the cutting device may be an electro-cautery probe. It will be appreciated that other medical devices needing to be cleaned fall within the scope of the invention.

In some embodiments, the method may include heating the cleaning solution and the surface of the device to a cleaning temperature. In some embodiments, the cleaning temperature may be about 75° F. to about 250° F. In some embodiments, the cleaning temperature may be about 75° F. to about 200° F. In some embodiments, the cleaning temperature may be about 75° F. to about 175° F. In some embodiments, the cleaning temperature may be about 100° F. to about 150° F.

In some embodiments, the method may further include sonicating the cleaning solution and the surface of the device. In some embodiments, the step of sonicating may be performed for up to 2 hours. In some embodiments, the step of sonicating may be performed for up about 1.5 hours. In some embodiments, the step of sonicating may be performed for about 2 minutes to about 1.5 hours. In some embodiments, the step of sonicating may be performed for about 10 minutes to about 45 minutes. In some embodiments, the step of sonicating may be performed for about 20 minutes. In some embodiments, the step of sonicating may be performed for less than about 1 hour.

In some embodiments, the method may further include rinsing the surface. In some embodiments, the step of rinsing may be performed after the step of sonicating. In some embodiments, the step of rinsing may include rinsing the surface with water.

In some embodiments, the device may be a medical device. In some embodiments, the medical device may be a cutting device. In some embodiments, the cutting device may be an electro-cautery probe.

According to another aspect of the present disclosure, a kit to be supplied for cleaning a surface of a device may include a cleaning solution, a container including a brim and a floor located spaced-apart from the brim to locate a sidewall therebetween and formed to include an interior product-storage region, and a lid coupled to the brim to block-selectively access to the interior product-storage region. In some embodiments, the cleaning solution may be located within the interior product-storage region. In some embodiments, the device may be a medical device. In some embodiments, the medical device may be a cutting device. In some embodiments, the cutting device may be an electro-cautery probe. In some embodiments, the lid may be configured to be punctured by the device.

These and other features of the present disclosure will become more apparent from the following description of the illustrative embodiments.

### BRIEF DESCRIPTION OF THE DRAWINGS

FIG. 1 is a diagrammatic chart of a method of using a cleaning solution in accordance with the present disclosure;

FIG. 2 shows a kit that includes a container, the cleaning solution located within the container, and a lid coupled to the container; and

FIG. 3 is a plot of mV versus time for cleaned electro-cautery probes.

### DEFINITIONS

As used herein, the term “alkyl” includes a chain of carbon atoms, which is optionally branched and contains from 1 to 20 carbon atoms. It is to be further understood that in certain embodiments, alkyl may be advantageously of limited length, including C₁-C₂₀, C₁₀-C₂₀, C₁-C₁₂, C₁-C₁₀, C₁-C₉, C₁-C₈, C₁-C₇, C₁-C₆, and C₁-C₄. Illustratively, such particularly limited length alkyl groups, including C₁-C₈, C₁-C₇, C₁-C₆, and C₁-C₄, and the like may be referred to as “lower alkyl.” Illustrative alkyl groups include, but are not limited to, methyl, ethyl, n-propyl, isopropyl, n-butyl, isobutyl, sec-butyl, tert-butyl, pentyl, 2-pentyl, 3-pentyl, neopentyl, hexyl, heptyl, octyl, and the like. Alkyl may be substituted or unsubstituted. Typical substituent groups include cycloalkyl, aryl, heteroaryl, heteroalicyclic, hydroxy, alkoxy, aryloxy, mercapto, alkylthio, arylthio, cyano, halo, carbonyl, oxo, (═O), thiocarbonyl, O-carbamyl, N-carbamyl, O-thiocarbamyl, N-thiocarbamyl, C-amido, N-amido, C-carboxy, O-carboxy, nitro, and amino, or as described in the various embodiments provided herein. It will be understood that “alkyl” may be combined with other groups, such as those provided above, to form a functionalized alkyl. By way of example, the combination of an “alkyl” group, as described herein, with a “carboxy” group may be referred to as a “carboxyalkyl” group. Other non-limiting examples include hydroxyalkyl, aminoalkyl, and the like.

As used herein, the term “alkylene” refers to a divalent-alkyl-group in which alkyl is as defined previously. Exemplary alkylene groups include —CH₂—, —(CH₂)₂— and —C(CH₃)HCH₂—.

As used herein, the term “alkenyl” includes a chain of carbon atoms, which is optionally branched, and contains from 2 to 20 carbon atoms, and also includes at least one carbon-carbon double bond (i.e. C═C). It will be understood that in certain embodiments, alkenyl may be advantageously of limited length, including C₂-C₂₀, C₁₀-C₂₀, C₂-C₁₂, C₂-C₉, C₂-C₈, C₂-C₇, C₂-C₆, and C₂-C₄. Illustratively, such particularly limited length alkenyl groups, including C₂-C₈, C₂-C₇, C₂-C₆, and C₂-C₄ may be referred to as lower alkenyl. Alkenyl may be unsubstituted or substituted as described for alkyl or as described in the various embodiments provided herein. Illustrative alkenyl groups include, but are not limited to, ethenyl, 1-propenyl, 2-propenyl, 1-, 2-, or 3-butenyl, and the like.

As used herein, the term “alkenylene” refers to a divalent -alkenyl-group in which alkenyl is as defined previously. Exemplary alkenylene groups include —CH═CH—, —CH═CHCH₂—, and —CH₂CH═CH—.

As used herein, the term “alkynyl” includes a chain of carbon atoms, which is optionally branched, and contains from 2 to 20 carbon atoms, and includes at least one carbon-carbon triple bond (i.e. C≡C). It will be understood that in certain embodiments alkynyl may each be advantageously of limited length, including C₂-C₂₀, C₁₀-C₂₀, C₂-C₁₂, C₂-C₉, C₂-C₈, C₂-C₇, C₂-C₆, and C₂-C₄. Illustratively, such particularly limited length alkynyl groups, including C₂-C₈, C₂-C₇, C₂-C₆, and C₂-C₄ may be referred to as lower alkynyl. Alkynyl may be unsubstituted or substituted as described for alkyl or as described in the various embodiments provided herein. Illustrative alkynyl groups include, but are not limited to, ethynyl, 1-propynyl, 2-propynyl, 1-, 2-, or 3-butynyl, and the like.

As used herein, the term “alkynylene” refers to a divalent-alkynyl-group in which—alkynyl—is as defined previously. Exemplary alkynylene groups include ethynyl and propargyl.

As used herein, the term “aryl” refers to an all-carbon monocyclic or fused-ring polycyclic groups of 6 to 12 carbon atoms having a completely conjugated pi-electron system. It will be understood that in certain embodiments, aryl may be advantageously of limited size such as C₆-C₁₀ aryl. Illustrative aryl groups include, but are not limited to, phenyl, naphthalenyl, and anthracenyl. The aryl group may be unsubstituted or substituted as described for alkyl or as described in the various embodiments provided herein.

As used herein, the term “arylene” refers to a divalent-aryl-group in which aryl is as defined previously. Exemplary arylene groups include—phenylene—and—napthalenylene—.

As used herein, the term “cycloalkyl” refers to a 3 to 15 member all-carbon monocyclic ring, an all-carbon 5-member/6-member or 6-member/6-member fused bicyclic ring, or a multicyclic fused ring (a “fused” ring system means that each ring in the system shares an adjacent pair of carbon atoms with each other ring in the system) group where one or more of the rings may contain one or more double bonds but the cycloalkyl does not contain a completely conjugated pi-electron system. It will be understood that in certain embodiments, cycloalkyl may be advantageously of limited size such as C₃-C₁₃, C₃-C₆, C₃-C₆ and C₄-C₆. The cycloalkyl may be unsubstituted or substituted as described for alkyl or as described in the various embodiments provided herein. Illustrative cycloalkyl groups include, but are not limited to, cyclopropyl, cyclobutyl, cyclopentyl, cyclopentenyl, cyclopentadienyl, cyclohexyl, cyclohexenyl, cycloheptyl, adamantyl, norbornyl, norbornenyl, 9H-fluoren-9-yl, and the like.

As used herein, the term “cycloalkylene” refers to a divalent -cycloalkyl-group in which cycloalkyl is as defined previously. Exemplary cycloalkylene groups include—cyclohexylene—and—cylcopentylene—.

In accordance with the invention, the term “heteroalkyl” includes a chain of atoms that includes both carbon and at least one heteroatom, and is optionally branched. It is to be further understood that in certain embodiments, heteroalkyl may be advantageously of limited length, including C₁-C₂₀, C₁₀-C₂₀, C₁-C₁₂, C₁-C₁₀, C₁-C₉, C₁-C₈, C₁-C₇, C₁-C₆, and C₁-C₄. Illustratively, such particularly limited length heteroalkyl groups, including C₁-C₈, C₁-C₇, C₁-C₆, and C₁-C₄, and the like may be referred to as “lower heteroalkyl.” Illustrative heteroatoms include nitrogen, oxygen, and sulfur. In certain variations, illustrative heteroatoms also include phosphorus and selenium.

As used herein, the term “heteroalkylene” refers to a divalent -heteroalkyl-group in which heteroalkyl is as defined previously. Exemplary heteroalkylene groups include—ethoxylene—.

As used herein, the term “heteroalkenyl” includes both a chain of carbon atoms which is optionally branched and at least one heteroatom, and also includes at least one carbon-carbon double bond (i.e. C═C). It will be understood that in certain embodiments, heteroalkenyl may be advantageously of limited length, including C₂-C₂₀, C₁₀-C₂₀, C₂-C₁₂, C₂-C₉, C₂-C₈, C₂-C₇, C₂-C₆, and C₂-C₄. Illustratively, such particularly limited length heteroalkenyl groups, including C₂-C₈, C₂-C₇, C₂-C₆, and C₂-C₄ may be referred to as lower heteroalkenyl. Heteroalkenyl may be unsubstituted or substituted as described for alkyl or as described in the various embodiments provided herein. Illustrative heteroatoms include nitrogen, oxygen, and sulfur. In certain variations, illustrative heteroatoms also include phosphorus and selenium.

As used herein, the term “heteroalkynyl” includes both a chain of carbon atoms which is optionally branched and at least one heteroatom and also includes at least one carbon-carbon double bond (i.e. C≡C). It will be understood that in certain embodiments, heteroalkynyl may be advantageously of limited length, including C₂-C₂₀, C₁₀-C₂₀,C₂-C₁₂, C₂-C₉, C₂-C₈, C₂-C₇, C₂-C₆, and C₂-C₄. Illustratively, such particularly limited length heteroalkynyl groups, including C₂-C₈, C₂-C₇, C₂-C₆, and C₂-C₄ may be referred to as lower heteroalkynyl. Heteroalkynyl may be unsubstituted or substituted as described for alkyl or as described in the various embodiments provided herein. Illustrative heteroatoms include nitrogen, oxygen, and sulfur. In certain variations, illustrative heteroatoms also include phosphorus and selenium.

As used herein, the term “heteroalkynylene” refers to a divalent-heteroalkynyl-group in which heteroalkynyl is as defined previously.

As used herein, the term “cycloheteroalkyl” including heterocyclyl and heterocycle, includes a chain of atoms that includes both carbon, such as heteroalkyl, and at least one heteroatom, and is optionally branched, where at least a portion of the chain is cyclic. Illustrative heteroatoms include nitrogen, oxygen, and sulfur. In certain variations, illustrative heteroatoms also include phosphorus and selenium. Illustrative cycloheteroalkyl include, but are not limited to, tetrahydrofuryl, pyrrolidinyl, tetrahydropyranyl, piperidinyl, morpholinyl, piperazinyl, homopiperazinyl, quinuclidinyl, and the like. As used herein, the term “heterocycloalkyl” refers to a monocyclic or fused ring group having in the ring(s) from 3 to 12 ring atoms, in which at least one ring atom is a heteroatom, such as nitrogen, oxygen or sulfur, the remaining ring atoms being carbon atoms. Heterocycloalkyl may optionally contain 1, 2, 3 or 4 heteroatoms.

Heterocycloalkyl may also have one or more double bonds, including double bonds to nitrogen (e.g. C═N or N═N) but does not contain a completely conjugated pi-electron system. It will be understood that in certain embodiments, heterocycloalkyl may be advantageously of limited size such as 3- to 7-membered heterocycloalkyl, 5- to 7-membered heterocycloalkyl, and the like. Heterocycloalkyl may be unsubstituted or substituted as described for alkyl or as described in the various embodiments provided herein. Illustrative heterocycloalkyl groups include, but are not limited to, oxiranyl, thianaryl, azetidinyl, oxetanyl, tetrahydrofuranyl, pyrrolidinyl, tetrahydropyranyl, piperidinyl, 1,4-dioxanyl, morpholinyl, 1,4-dithianyl, piperazinyl, oxepanyl, 3,4-dihydro-2H-pyranyl, 5,6-dihydro-2H-pyranyl, 2H-pyranyl, 1, 2, 3, 4-tetrahydropyridinyl, and the like.

As used herein, the term “cycloheteroalkylene” refers to a divalent-cycloheteroalkyl-group in which cycloheteroalkyl is as defined previously. Exemplary cycloheteroalkylene groups include—morpholinylene—and—piperazinylene—.

As used herein, the term “heteroaryl” refers to a monocyclic or fused ring group of 5 to 12 ring atoms containing one, two, three, or four ring heteroatoms selected from nitrogen, oxygen, and sulfur, the remaining ring atoms being carbon atoms, and also having a completely conjugated pi-electron system. It will be understood that in certain embodiments, heteroaryl may be advantageously of limited size such as 3- to 7-membered heteroaryl, 5- to 7-membered heteroaryl, and the like. Heteroaryl may be unsubstituted or substituted as described for alkyl or as described in the various embodiments provided herein. Illustrative heteroaryl groups include, but are not limited to, pyrrolyl, furanyl, thiophenyl, imidazolyl, oxazolyl, thiazolyl, pyrazolyl, pyridinyl, pyrimidinyl, quinolinyl, isoquinolinyl, purinyl, tetrazolyl, triazinyl, pyrazinyl, tetrazinyl, quinazolinyl, quinoxalinyl, thienyl, isoxazolyl, isothiazolyl, oxadiazolyl, thiadiazolyl, triazolyl, benzimidazolyl, benzoxazolyl, benzthiazolyl, benzisoxazolyl, benzisothiazolyl, carbazoloyl, and the like.

As used herein, the term “heteroarylene” refers to a divalent-heteroaryl-group in which heteroaryl is as defined previously. Exemplary heteroarylene groups include—imidazoylene—and—furanylene—.

As used herein, “hydroxy” or “hydroxyl” refers to an —OH group.

As used herein, “alkoxy” refers to both an —O-(alkyl) or an —O-(unsubstituted cycloalkyl) group. Representative examples include, but are not limited to, methoxy, ethoxy, propoxy, butoxy, cyclopropyloxy, cyclobutyloxy, cyclopentyloxy, cyclohexyloxy, and the like.

As used herein, “halo” or “halogen” refers to fluorine, chlorine, bromine or iodine.

As used herein, “cyano” refers to a —CN group.

The term “oxo” represents a carbonyl oxygen. For example, a cyclopentyl substituted with oxo is cyclopentanone.

As used herein, “optional” or “optionally” means that the subsequently described event or circumstance may but need not occur, and that the description includes instances where the event or circumstance occurs and instances in which it does not. For example, “heterocycle group optionally substituted with an alkyl group” means that the alkyl may, but need not be present, and the description includes situations where the heterocycle group is substituted with an alkyl group and situations where the heterocycle group is not substituted with the alkyl group.

As used herein, “independently” means that the subsequently described event or circumstance is to be read on its own relative to other similar events or circumstances. For example, in a circumstance where several equivalent hydrogen groups are optionally substituted by another group described in the circumstance, the use of “independently optionally” means that each instance of a hydrogen atom on the group may be substituted by another group, where the groups replacing each of the hydrogen atoms may be the same or different. Or for example, where multiple groups exist all of which can be selected from a set of possibilities, the use of “independently” means that each of the groups can be selected from the set of possibilities separate from any other group, and the groups selected in the circumstance may be the same or different.

### DETAILED DESCRIPTION

During use, medical devices such as cutting devices may develop a layer of eschar on the surface. Although this eschar layer may typically form on the layer of the cutting device, it is possible that other instruments in proximity to the cutting device may also develop a layer of eschar. This layer of eschar may comprise the thermal breakdown products from fats, proteins, and other tissue components. These eschar layers can be difficult to remove without damaging the surfaces of the medical devices. For example, removing the layer of eschar, sometimes called char, with an organic solvent, such as isopropanol, may over time damage the surface of the electro-cautery probe and decrease performance. Further, improper or incomplete removal of the eschar may lead to decreased performance of the medical device. A cleaning solution in accordance with the present disclosure may be used to clean such devices.

Devices in accordance with the present disclosure may include thermal cutters such as a radio frequency cutting blade, a thermal blade, or an electrocautery probe, for example. These thermal cutters are capable of generating an eschar on the blade or cutting surface during use. Other cutting devices such as ultrasonic cutting blades are also contemplated. It will be appreciated that other medical devices needing to be cleaned fall within the scope of the invention. For examples, forceps or other devices that may be proximate to the cutting device and interact smoke or particulate matter from the cutting device may also require cleaning. Other non-medical devices such as grills or ovens may also be cleaned in accordance with the present disclosure. The cleaning solution may be used to remove residue or build-up from any suitable metallic surface such as stainless steel.

The cleaning solution described herein may include an organic acid and a surfactant blend. In some embodiments, the cleaning solution further includes a passivation solution. In some illustrative embodiments, a method is described to use the cleaning solution to clean a medical device such as an electro-cautery probe. In another illustrative embodiment, a kit containing the cleaning solution is described.

The compounds described herein may contain one or more chiral centers, or may otherwise be capable of existing as multiple stereoisomers. Accordingly, it is to be understood that the present invention includes pure stereoisomers as well as mixtures of stereoisomers, such as enantiomers, diastereomers, and enantiomerically or diastereomerically enriched mixtures. The compounds described herein may be capable of existing as geometric isomers. Accordingly, it is to be understood that the present invention includes pure geometric isomers or mixtures of geometric isomers.

As used herein, the term “acceptable salt” refers to those salts which counter ions may be used in accordance with the present disclosure. Such salts include:

(1) acid addition salts, which can be obtained by reaction of the free base of the parent compound with inorganic acids such as hydrochloric acid, hydrobromic acid, nitric acid, phosphoric acid, sulfuric acid, and perchloric acid and the like, or with organic acids such as acetic acid, oxalic acid, (D) or (L) malic acid, maleic acid, methane sulfonic acid, ethanesulfonic acid, p-toluenesulfonic acid, salicylic acid, tartaric acid, citric acid, succinic acid or malonic acid and the like; or

(2) salts formed when an acidic proton present in the parent compound either is replaced by a metal ion, e.g., an alkali metal ion, an alkaline earth ion, or an aluminum ion; or coordinates with an organic base such as ethanolamine, diethanolamine, triethanolamine, trimethamine, N-methylglucamine, and the like.

Acceptable salts are well known to those skilled in the art, and any such acceptable salt may be contemplated in connection with the embodiments described herein.

Suitable acid addition salts are formed from acids, which form non-toxic salts. Illustrative examples include the acetate, aspartate, benzoate, besylate, bicarbonate/carbonate, bisulphate/sulphate, borate, camsylate, citrate, edisylate, esylate, formate, fumarate, gluceptate, gluconate, glucuronate, hexafluorophosphate, hibenzate, hydrochloride/chloride, hydrobromide/bromide, hydroiodide/iodide, isethionate, lactate, malate, maleate, malonate, mesylate, methylsulphate, naphthylate, 2-napsylate, nicotinate, nitrate, orotate, oxalate, palmitate, pamoate, phosphate/hydrogen phosphate/dihydrogen phosphate, saccharate, stearate, succinate, tartrate, tosylate and trifluoroacetate salts.

Suitable base salts of the compounds described herein are formed from bases, which form non-toxic salts. Illustrative examples include the arginine, benzathine, calcium, choline, diethylamine, diolamine, glycine, lysine, magnesium, meglumine, olamine, potassium, sodium, tromethamine and zinc salts. Hemisalts of acids and bases may also be formed, for example, hemisulphate and hemicalcium salts. It is appreciated that the compounds described herein may exist in unsolvated forms as well as solvated forms, including hydrated forms. In general, the solvated forms are equivalent to unsolvated forms and are encompassed within the scope of the present invention. The compounds described herein may exist in multiple crystalline or amorphous forms. In general, all physical forms are equivalent for the uses contemplated by the present invention and are intended to be within the scope of the present invention.

In illustrative embodiments, the cleaning solution may have a pH between about 0.5 and about 7. The cleaning solution may have one of several different pHs. The pH of the cleaning solution may be one of the following values: about 0.5, about 0.8, about 1, about 1.2, about 1.4, about 1.6, about 1.8, about 2, about 2.1, about 2.2, about 2.3, about 2.4, about 2.5, about 2.6, about 2.7, about 2.8, about 2.9, about 3, about 3.1, about 3.2, about 3.3, about 3.4, about 3.5, about 3.6, about 3.7, about 3.8, about 3.9, about 4, about 4.2, about 4.4, about 4.6, about 4.7, about 5, about 5.5, about 6, about 6.5, and about 7. It is within the scope of the present disclosure for the pH of the cleaning solution to fall within one of many ranges. In a set of ranges, the pH of the cleaning solution is one of the following ranges: about 0.5 to about 7, about 0.5 to about 6, about 0.5 to about 5, about 1 to about 5, about 1 to about 4, about 1.5 to about 4, about 2 to about 4, about 2.2 to about 4, about 2.5 to about 4, and about 2.5 to about 3.5.

In illustrative embodiments, the cleaning solution may have a cloud point between about 75° F. and about 150° F. The cleaning solution may have one of several different cloud points depending on the surfactants in the cleaning solution. The cloud point of the cleaning solution may be one of the following values: about 75° F., about 80° F., about 85° F., about 90° F., about 95° F., about 100° F., about 101° F., about 102° F., about 103° F., about 104° F., about 105° F., about 106° F., about 107° F., about 108° F., about 109° F., about 110° F., about 111° F., about 112° F., about 113° F., about 114° F., about 115° F., about 116° F., about 117° F., about 118° F., about 119° F., about 120° F., about 125 ° F., about 130° F., about 135° F., about 140° F., about 145° F., and about 150° F. It is within the scope of the present disclosure for the cloud point of the cleaning solution to fall within one of many ranges. In a set of ranges, the cloud point of the cleaning solution is one of the following ranges: about 75° F. to about 150° F., about 75° F. to about 140° F., about 75° F. to about 130° F., about 85° F. to about 130° F., about 90° F. to about 130° F., about 95° F. to about 130° F., about 105° F. to about 130° F., and about 105° F. to about 120° F.

It should be understood that the cleaning solution described herein may be prepared as a concentrate and then diluted. Illustratively, the weight percentage values provided herein may be concentrated about 2 times, about 3 times about 4 times, about 5 times, about 6 times, about 7 times, about 8 times, about 9 times, or about 10 times the described value.

In some embodiments, the cleaning solution in accordance with the present disclosure comprises an organic acid. Illustratively, the organic acid may be an organic compound having acidic properties. Illustrative organic acids may comprise a carboxylic acid, a sulfonic acid, a phosphoric acid, combinations thereof, or any suitable alternative. In some embodiments, the organic acid may act as a chelator to bind free metal cations. While organic acids are described herein, mineral acids such as hydrochloric, hydrofluoric, and any suitable alternative or combination are also contemplated.

In some embodiments, the organic acid may be a compound of the formula

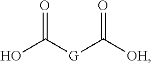

or a salt thereof, wherein G is selected from the group consisting of a bond, C₁₋₁₀ alkylene, C₂₋₁₀ alkenylene, C₂₋₁₀ alkynylene, C₁₋₁₀ heteroalkylene, C₂₋₁₀ heteroalkenylene, and C₂₋₁₀ heteroalkynylene, and wherein each hydrogen atom in C₁₋₁₀ alkylene, C₂₋₁₀ alkenylene, C₂₋₁₀ alkynylene, C₁₋₁₀ heteroalkylene, C₂₋₁₀ heteroalkenylene, and C₂₋₁₀ heteroalkynylene may be optionally substituted with one or more R^{N}, wherein each R^{N} is independently selected from the group consisting of—halo, oxo, —OH, —CN, —NO₂, —CF₃, —OCF₃, —CO₂H, and —NH₂.

In some embodiments, G is a bond and the organic acid is equivalent to oxalic acid, or a salt thereof. In some embodiments, G is —CH₂C(OH)(CO₂H)CH₂— and the organic acid is equivalent to citric acid, or a salt thereof. In some embodiments, the organic acid is phosphoric acid.

In illustrative embodiments, the organic acid may be up to 15% by weight of the cleaning solution. The organic acid may be one of several different percentages by weight of the cleaning solution. The percentage by weight of the organic acid may be one of the following values: about 0.1%, about 0.2%, about 0.3%, about 0.4%, about 0.5%, about 0.6%, about 0.7%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.2%, about 2.5%, about 3%, about 3.5%, about 4%, about 4.5%, about 5%, about 6%, about 7%, about 10%, and about 15% by weight of the cleaning solution. It is within the scope of the present disclosure for the percentage by weight of the organic acid in the cleaning solution to fall within one of many ranges. In a set of ranges, the percentage by weight of the organic acid is one of the following ranges: about 0.1% to about 15%, about 0.1% to about 10%, about 0.5% to about 15%, about 0.5% to about 10%, about 0.5% to about 7%, about 0.5% to about 5%, about 0.5% to about 3.5%, and about 0.5% to about 2% by weight of the cleaning solution. In some examples, the organic acid is about 1% by weight of the cleaning solution. In some examples, the organic acid is about 2% by weight of the cleaning solution. In some examples, the organic acid is about 3% by weight of the cleaning solution.

In some embodiments, a cleaning solution in accordance with the present disclosure comprises a surfactant blend. Illustratively, the surfactant blend cooperates with the organic acid to remove eschar from the device surface. In some embodiments, the surfactant blend consists of a single surfactant, sometimes called a primary surfactant. In some embodiments, the surfactant blend comprises a primary surfactant and a co-surfactant. In some embodiments, the surfactant blend comprises a primary surfactant, a first co-surfactant, and a second co-surfactant. In some embodiments, the surfactant blend comprises an emulsifier. In some embodiments, the surfactant blend comprises a first surfactant, a first co-surfactant, a second co-surfactant, and an emulsifier.

In some embodiments, surfactants of the surfactant blend may have a low critical micelle concentration (CMC) and a Hydrophile-Lipophile Balance (HLB). In some embodiments, a surfactant of the surfactant blend may also act as an emulsifier. In some embodiments, a surfactant of the surfactant blend may also act as a defoaming agent.

In some embodiments, the surfactant blend comprises a non-ionic surfactant. In some embodiments, the surfactant blend comprises an ionic surfactant. In some embodiments, the surfactant blend comprises a non-ionic surfactant and an ionic surfactant. Suitable non-ionic surfactants may comprise alkyls, alkenyls, alkynyls, heteroalkyls, heteroalkenyls, heteroalkynls, cycloalkyls, cycloalkenyls, cycloalkynls, cycloheteroalkyls, cycloheteroalkenyls, cycloheteroalkynyls, aryls, combinations thereof, or any suitable alternative. Suitable ionic surfactants may be cationic, anionic, zwitterionic, combinations thereof, or any suitable alternative.

In some embodiments, the surfactant blend may be up to 50% by weight of the cleaning solution. The surfactant blend may be one of several different percentages by weight of the cleaning solution. The percentage by weight of the surfactant blend may be one of the following values about 0.2%, about 0.5%, about 0.8%, about 1%, about 1.2%, about 1.4%, about 1.6%, about 1.8%, about 2%, about 2.2%, about 2.4%, about 2.6%, about 2.7%, about 2.8%, about 2.9%, about 3%, about 3.1%, about 3.2%, about 3.3%,about 3.4%, about 3.5%, about 3.6%, about 3.7%, about 3.8%, about 3.9%, about 4%, about 4.1%, about 4.2%, about 4.3%, about 4.4%, about 4.5%, about 5%, about 6%, about 7%, about 8%, about 9%, about 10%, about 15%, about 20%, about 25%, about 30%, about 35%, about 40%, about 45%, or about 50% by weight of the cleaning solution. It is within the scope of the present disclosure for the percentage by weight of the surfactant blend in the cleaning solution to fall within one of many ranges. In a set of ranges, the percentage by weight of the surfactant blend is one of the following ranges: about 0.2% to about 50%, about 0.2%, to about 40%, about 0.2% to about 35%, about 0.2% to about 30%, about 0.2% to about 25%, about 5% to about 25%, about 0.2% to about 10%, about 0.5% to about 10%, about 0.5% to about 6%, about 1% to about 6%, about 1% to about 5%, about 2% to about 5%, and about 2.5% to about 5% by weight of the cleaning solution. In some examples, the surfactant blend is about 3.5% by weight of the cleaning solution.

In some embodiments, the surfactant blend comprises a primary surfactant. In some embodiments, the primary surfactant is an ionic surfactant. Illustratively, the primary surfactant may act as a solubilizer for debris on the surface. The debris may include proteins (denatured or in their native form), polymerized or partially-polymerized fatty acids, and/or polymerized or partially-polymerized phospholipids.

In some embodiments, the primary surfactant may comprise a compound of the formula

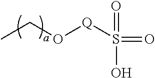

or a salt thereof, wherein a is an integer from 1-20 and Q is a bond or —C(O)CH₂—. In some embodiments, a is 11, Q is a bond, and the surfactant is equivalent sodium lauryl sulfate. In some embodiments, a is 11 and Q is —C(O)CH₂—, and the primary surfactant is equivalent to sodium lauryl sulfoacetate

In some embodiments, the primary surfactant is a certain percentage by weight of the cleaning solution. The percentage by weight of the primary surfactant may be one of the following values about 0.2%, about 0.4%, about 0.5%, about 0.6%, about 0.7%, about 0.8%, about 0.9%, about 1%, about 1.1%, about 1.2%, about 1.4%, about 1.6%, about 1.8%, about 2%, about 2.2%, about 2.4%, about 2.6%, about 2.8%, about 3%, about 3.5%, about 4%, about 4.5%, about 5%, about 6%, about 7%, about 8%, about 9%, about 10%, about 12%, about 14%, about 16%, about 18%, and about 20% by weight of the solution. It is within the scope of the present disclosure for the percentage by weight of the primary surfactant in the cleaning solution to fall within one of many ranges. In a set of ranges, the percentage by weight of the primary surfactant is one of the following ranges: about 0.1% to about 20%, about 0.2% to about 20%, about 0.2% to about 15%, about 0.2% to about 15%, about 0.5% to about 15%, about 0.5% to about 10%, about 1% to about 10%, or about 1% to about 8% by weight of the cleaning solution. In some examples, the primary surfactant is about 5% by weight of the cleaning solution.

In some embodiments, the primary surfactant has an HLB of at least about 10, at least about 11, at least about 12, at least about 13, at least about 15, at least about 20, at least 25, or at least 30. In some embodiments, the surfactant has an HLB of about 10, about 15, about 20, about 25, about 30, about 35, about 40, or about 45. In some embodiments, the first surfactant has an HLB selected from a range of about 10 to about 45, about 15 to about 45, about 20 to about 45, about 25 to about 45, and about 30 to about 45.

In some embodiments, the surfactant blend comprises an emulsifier. In some embodiments, the emulsifier comprises a polysorbate of the formula

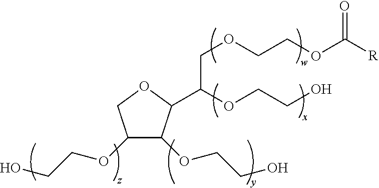

or a salt thereof, wherein each w, x, y, and z is respectively an integer from 1-20, the sum of w, x, y, and z is a multiple of 20, R is selected from the group consisting of C₁₀₋₂₀ alkyl, C₁₋₁₀ alkyl, C₁₀₋₂₀ alkenyl, C₂₋₁₀ alkenyl, C₁₀₋₂₀ alkynyl, C₂-10 alkynyl, C₁₀₋₂₀ heteroalkyl, C₁₋₁₀ heteroalkyl, C₁₀₋₂₀ heteroalkenyl, C₂₋₁₀ heteroalkenyl, _{C10-20} heteroalkynyl, and C₂₋₁₀ heteroalkynyl, wherein each hydrogen atom in C₁₀₋₂₀ alkyl, C₁₋₁₀ alkyl, C₁₀₋₂₀ alkenyl, C₂₋₁₀ alkenyl, C₁₀₋₂₀ alkynyl, C₂₋₁₀ alkynyl, C₁₀₋₂₀ heteroalkyl, C₁₋₁₀ heteroalkyl, C₁₀₋₂₀ heteroalkenyl, C₂₋₁₀ heteroalkenyl, C₁₀₋₂₀ heteroalkynyl, and C₂₋₁₀ heteroalkynyl may be optionally substituted with one or more R^{M}, and wherein each R^{M} is independently selected from the group consisting of—halo, oxo, —OH, —CN, —NO₂, —CF₃, —OCF₃, —CO₂H, and —NH₂.

In some embodiments, the sum of w, x, y, and z is 20 and R is C₁₀-20 alkyl. In some embodiments, the sum of w, x, y, and z is 20 and R is C₁₀₋₂₀ alkenyl. In some embodiments, the sum of w, x, y, and z is 20 and R is —(CH₂)₇CH↑CH(CH₂)₇CH₃. In some embodiments, the surfactant is polysorbate 20. In some embodiments, the surfactant is polysorbate 40. In some embodiments, the surfactant is polysorbate 60. In some embodiments, the surfactant is polysorbate 80.

In some embodiments, the emulsifier is a certain percentage by weight of the cleaning solution. The percentage by weight of the emulsifier may be one of the following values about 0.2%, about 0.4%, about 0.5%, about 0.6%, about 0.7%, about 0.8%, about 0.9%, about 1%, about 1.1%, about 1.2%, about 1.4%, about 1.6%, about 1.8%, about 2%, about 2.2%, about 2.4%, about 2.6%, about 2.8%, about 3%, about 3.5%, about 4%, about 4.5%, about 5%, about 6%, about 7%, about 8%, about 9%, about 10%, about 12%, about 14%, about 16%, about 18%, and about 20% by weight of the solution. It is within the scope of the present disclosure for the percentage by weight of the emulsifier in the cleaning solution to fall within one of many ranges. In a set of ranges, the percentage by weight of the emulsifier is one of the following ranges: about 0.1% to about 20%, about 0.1% to about 10%, about 0.1% to about 5%, about 0.1% to about 4%, about 0.1% to about 3%, about 0.2% to about 4%, about 0.3% to about 4%, about 0.3% to about 3%, about 0.3% to about 2%, about 0.2% to about 1%, about 1% to about 4%, and about 0.3% to about 1.6% by weight of the cleaning solution. In some examples, the emulsifier is about 0.3% by weight of the cleaning solution. In some examples, the emulsifier is about 0.5% by weight of the cleaning solution.

In some embodiments, the surfactant may be a co-surfactant. In some embodiments, the co-surfactant may be a first co-surfactant or a second co-surfactant. Illustratively, the first co-surfactant may be able to disperse the primarily hydrophobic composition from the eschar on the surface, which may include any non-stick surface modulators used to reduce tissue cling to the electro-cautery probes.

In some embodiments, the first co-surfactant is an ethoxylated alcohol. In some embodiments, the ethoxylated alcohol comprises a compound of the formula

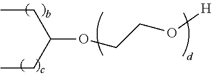

or a salt thereof, wherein each of b and c is independently an integer from 0 to 12, and d is an integer from 3 to 40.

Illustratively, d may be any integer from 3 to 40. In some embodiments, d can be selected from the group consisting of 3, 5, 7, 9, 12, 15, 20, 30, and 40. In some embodiments, d is 7 or 9. In some embodiments, the sum of b+c is from 8 to 14. In some embodiments, d is 7 and the sum of b+c is from 8 to 14. In some embodiments, the surfactant is Tergitol™ 15-S-7 available from The Dow Chemical Company. In some embodiments, the co-surfactant is Bio-Soft GSB-9.

In some embodiments, the first co-surfactant has an HLB of at least about 5, at least about 8, at least about 10, at least about 11, at least about 12, at least about 13, or at least about 15. In some embodiments, the HLB of the first co-surfactant is about 8, about 9, about 10, about 11, about 12, about 13, about 14, about 15, about 16, about 18, or about 20. In some embodiments, the first surfactant has an HLB selected from a range of about 8 to about 20, about 8 to about 18, about 10 to about 18, about 12 to about 18, or about 12 to about 16.

In some embodiments, the first co-surfactant is a certain percentage by weight of the cleaning solution. The percentage by weight of the first co-surfactant may be one of the following values about 0.2%, about 0.4%, about 0.5%, about 0.6%, about 0.7%, about 0.8%, about 0.9%, about 1%, about 1.1%, about 1.2%, about 1.4%, about 1.6%, about 1.8%, about 2%, about 2.2%, about 2.4%, about 2.6%, about 2.8%, about 3%, about 3.5%, about 4%, about 4.5%, about 5%, about 6%, about 7%, about 8%, about 9%, about 10%, about 12%, about 14%, about 16%, about 18%, and about 20% by weight of the solution. It is within the scope of the present disclosure for the percentage by weight of the first co-surfactant in the cleaning solution to fall within one of many ranges. In a set of ranges, the percentage by weight of the first co-surfactant is one of the following ranges: about 0.1% to about 20%, about 0.1% to about 10%, about 0.1% to about 5%, about 0.1% to about 4%, about 0.1% to about 3%, about 0.1% to about 1%, about 0.2% to about 4%, about 0.3% to about 4%, about 0.3% to about 3%, about 0.3% to about 2%, about 0.2% to about 1%, about 1% to about 4%, and about 0.2% to about 1.6% by weight of the cleaning solution. In some examples, the first co-surfactant is about 0.3% by weight of the cleaning solution.

Illustratively, the second co-surfactant may comprise or act as a wetting agent. Illustratively, the second co-surfactant may be dispersible or soluble in water. In some illustrative embodiments, the second co-surfactant may facilitate penetration of the debris with the cleaning solution.

In some embodiments, the second co-surfactant is an ethoxylated alcohol. In some embodiments, the ethoxylated alcohol comprises a compound of the formula

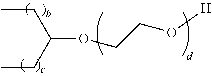

or a salt thereof, wherein each of b and c is independently an integer from 0 to 12, and d is an integer from 3 to 40. Illustratively, d may be any integer from 3 to 40. In some embodiments, d can be selected from the group consisting of 3, 5, 7, 9, 12, 15, 20, 30, and 40. In some embodiments, d is 3 and the sum of b +c is from 8 to 14. In some embodiments, the surfactant is Terigtol™ 15-S-3 available from The Dow Chemical Company. In some embodiments, the co-surfactant is Makon TD-3.

In some embodiments, the second co-surfactant surfactant has an HLB of at least about 3, at least about 4, at least about 6, or at least about 8. In some embodiments, the HLB of the first co-surfactant is about 3, about 4, about 5, about 6, about 7, about 8, about 9, about 10, about 11, about 12, or about 15. In some embodiments, the first surfactant has an HLB selected from a range of about 3 to about 15, about 3 to about 12, about 5 to about 12, about 6 to about 12, or about 6 to about 10.

In some embodiments, the second co-surfactant is a certain percentage by weight of the cleaning solution. The percentage by weight of the second co-surfactant may be one of the following values about 0.2%, about 0.4%, about 0.5%, about 0.6%, about 0.7%, about 0.8%, about 0.9%, about 1%, about 1.1%, about 1.2%, about 1.4%, about 1.6%, about 1.8%, about 2%, about 2.2%, about 2.4%, about 2.6%, about 2.8%, about 3%, about 3.5%, about 4%, about 4.5%, about 5%, about 6%, about 7%, about 8%, about 9%, about 10%, about 12%, about 14%, about 16%, about 18%, and about 20% by weight of the solution. It is within the scope of the present disclosure for the percentage by weight of the second co-surfactant in the cleaning solution to fall within one of many ranges. In a set of ranges, the percentage by weight of the second co-surfactant is one of the following ranges: about 0.1% to about 20%, about 0.1% to about 10%, about 0.1% to about 5%, about 0.1% to about 4%, about 0.1% to about 3%, about 0.1% to about 1%, about 0.2% to about 4%, about 0.3% to about 4%, about 0.3% to about 3%, about 0.3% to about 2%, about 0.2% to about 1%, about 1% to about 4%, and about 0.3% to about 1.6% by weight of the cleaning solution. In some examples, the second co-surfactant is about 0.3% by weight of the cleaning solution.

In some embodiments, the cleaning solution comprises a thickening agent, sometimes called a stabilizer, or sometimes called a gelling agent, to increase the viscosity of the solution. Illustratively, a cleaning solution having a higher viscosity may have a higher retention time on a surface. In some embodiments, the cleaning solution is a low viscosity cleaning solution and has a viscosity less than a high viscosity cleaning solution.

In some embodiments, the thickening agent comprises a polyol, a polysaccharide thickening agent, a protein-based thickening agent, a plant-based thickening agent, a mineral-based thickening agent, a synthetic thickening agent, and any suitable alternative or combination thereof. Illustrative polyols include glycerol, a derivative thereof, and any suitable alternative or combination thereof. Illustrative polysaccharide thickening agents include xanthan gum, pectins, alginates, guar gum, locust bean gum, plant starches, agar agar, carrageenan, and any suitable alternative or combination thereof. Illustrative alginates include sodium alginate, alginic acid and any suitable alternative or combination thereof. Illustrative protein-based thickening agents include gelatin, collagen, and any suitable alternative or combination thereof. Illustrative plant-based thickening agents include gum arabic and any suitable alternative thereof. Illustrative synthetic thickening agents include carbomers and any suitable alternative thereof.

In some embodiments, the cleaning solution may comprise at least 1 or at least 2 thickening agents. In some embodiments, a cleaning solution comprises 1, 2, or 3 thickening agents. In some examples, the cleaning solution comprises glycerol and at least one other thickening agent. In some embodiments, the cleaning solution comprises glycerol and a polysaccharide thickening agent. In some examples, the cleaning solution comprises glycerol and xanthan gum.

The thickening agent can be a certain percentage by weight of the cleaning solution. In some embodiments, the thickening agent is up to about 2%, up to about 5%, up to about 8%, up to about 10%, up to about 12%, up to about 14%, up to about 16%, up to about 18%, up to about 20%, up to about 22%, up to about 25%, up to about 30%, or up to about 35% by weight of the cleaning solution. In some embodiments, the thickening agent is at least about 2%, at least about 5%, at least about 8%, at least about 10%, at least about 12%, at least about 14%, at least about 16%, at least about 18%, or at least about 20% by weight of the cleaning solution. In some embodiments, the thickening agent is about 0.1%, about 0.2%, about 0.3%, about 0.4%, about 0.5%, about 1%, about 2%, about 3%, about 4%, about 5%, about 6%, about 7%, about 8%, about 9%, about 10%, about 12%, about 15%, about 20%, about 25%, or about 30% by weight of the cleaning solution. In some embodiments, the percentage by weight of the thickening agent in the cleaning solution is selected from a range of about 0.1% to about 30%, about 2% to about 30%, about 5% to about 30%, about 5% to about 25%, about 10% to about 25%, or about 15% to about 25%. In some embodiments, the percentage by weight of the thickening agent in the cleaning solution is selected from a range of about 0.1% to about 15%, about 0.1% to about 12%, about 0.3% to about 12%, about 0.5% to about 12%, about 0.5% to about 8%, or about 0.5% to about 5%.

In some embodiments, the thickening agent is added to adjust the viscosity to a desired value. In some embodiments, the viscosity of the high viscosity cleaning solution is at least 15,000 cps, at least about 20,000 cps, at least about 25,000 cps, at least about 30,000 cps, at least about 35,000 cps, or at least about 40,000 cps. In some embodiments, the viscosity of the cleaning solution is about 15,000 cps, about 20,000 cps, about 30,000 cps, about 35,000 cps, about 40,000 cps, about 45,000 cps, about 50,000 cps, about 55,000 cps, about 60,000 cps, about 65,000 cps, or about 75,000 cps. In some embodiments, the viscosity of the cleaning solution is selected from a range of about 15,000 cps to about 75,000 cps, about 25,000 cps to about 65,000 cps, about 30,000 cps to about 65,000 cps, about 30,000 cps to about 60,000 cps, or about 35,000 cps to about 55,000 cps.

In some embodiments, the cleaning solution may further comprise a passivation solution that promotes the formation of a corrosion-inhibiting passive layer. Illustratively, passivation of a metal surface may include the removal of free iron from the surface. In some embodiments, the passivation solution may be a mixture of more than one solution. In some embodiments, the passivation solution may act as an oxygen source. In some embodiments, the passivation solution comprises a peroxide. Exemplary peroxides include hydrogen peroxide (H₂O₂), alkyl peroxides, and aryl peroxides. In some embodiments, the passivation solution comprises a peroxide and an organic acid. In some embodiments, the passivation solution comprises a peroxide and ascorbic acid. In some embodiments, the passivation solution comprises H₂O₂ and ascorbic acid.

In illustrative embodiments, the passivation solution may be up to 15% by weight of the cleaning solution. The passivation solution may be one of several different percentages by weight of the cleaning solution. The percentage by weight of the passivation solution may be one of the following values: about 0.1%, about 0.5%, about 0.8%, about 0.9%, about 1%, about 1.1%, about 1.2%, about 1.3%, about 1.4%, about 1.5%, about 1.6%, about 1.7%, about 1.8%, about 1.9%, about 2%, about 2.1%, about 2.2%, about 2.3%, about 2.4%, about 2.5%, about 2.6%, about 2.7%, about 2.8%, about 3%, about 3.5%, about 4%, about 4.5%, about 5%, about 5.5%, about 6%, about 6.5%, about 7%, about 7.5%, about 8%, about 8.5%, about 9%, about 10%, about 12%, and about 15% by weight of the cleaning solution. It is within the scope of the present disclosure for the percentage by weight of the passivation solution to fall within one of many ranges. In a set of ranges, the percentage by weight of the passivation solution is one of the following ranges: about 0.1% to about 15%, about 0.1% to about 10%, about 0.5% to about 10%, about 0.5% to about 8%, about 0.5% to about 5%, about 0.5% to about 4%, about 1% to about 4%, about 1% to about 10%, about 2% to about 6%, and about 1.5% to about 4% by weight of the cleaning solution. In some examples, the passivation solution is about 3.5% by weight of the cleaning solution. In some examples, the passivation solution is about 4.5% by weight of the cleaning solution.

In some embodiments, the passivation solution comprises a peroxide and an organic acid in a molar ratio. The molar ratio of the peroxide to the organic acid may be about 25:1, about 20:1, about 15:1, about 14:1, about 13:1, about 12:1, about 11:1, about 10:1, about 9:1, about 8:1, about 7:1, about 6:1, about 5:1, about 4:1, about 3:1, about 2:1, and about 1:1. It is within the present disclosure for the molar ratio of the peroxide to the organic acid to fall within one of many ranges. In a set of ranges, the molar ratio the peroxide to the organic acid is one of the following ranges: about 25:1 to about 1:1, about 25:1 to about 3:1, about 25:1 to about 5:1, about 25:1 to about 15:1, and about 15:1 to about 5:1. It should be understood the molar ratios provided are equally applicable if the peroxide is hydrogen peroxide and the organic acid is ascorbic acid.

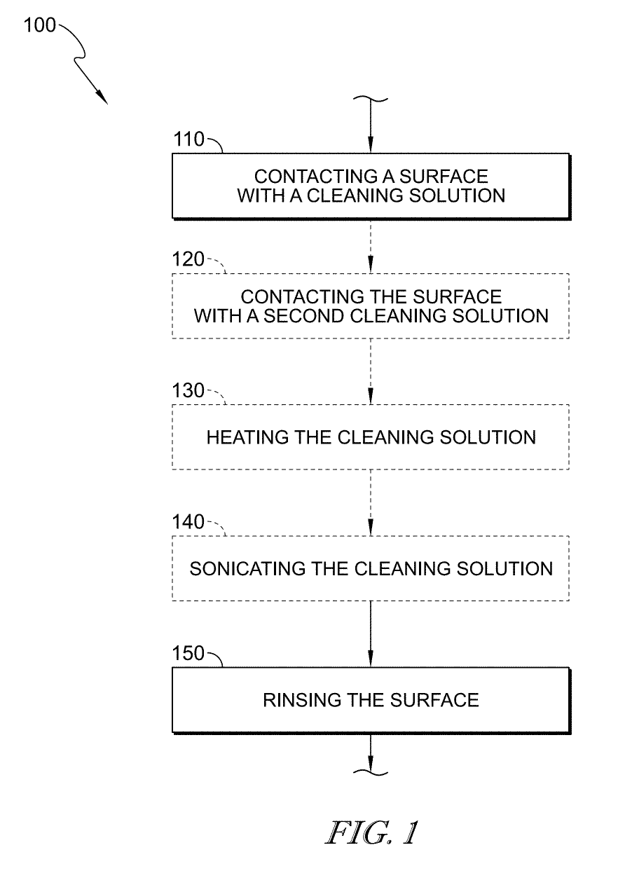

The cleaning solution in accordance with the present disclosure may be used in a method 100 to clean a surface of a device, as shown in FIG. 1. In some embodiments, the device is a medical device. In some exemplary embodiments, the medical device is an electro-cautery probe. In some embodiments, the method may include the steps of contacting the surface of the device with a cleaning solution. In some embodiments, the cleaning solution and the surface of the device are heated to a cleaning temperature. In some embodiments, the method may further include sonicating the cleaning solution and the surface of the device.

In some embodiments, the step of contacting 110 the surface of the device may include submerging the surface of the device in the cleaning solution. In some embodiments, the step of contacting may include spraying the surface of the device with the cleaning solution. In some embodiments, the step of contacting may include wiping the cleaning solution on the surface of the device.

Illustratively, the step of contacting 110 may be performed with either a low viscosity cleaning solution or a high viscosity cleaning solution. In some embodiments, the method 100 includes a step of contacting 110 a surface with a first cleaning solution and a second step of contacting 120 the surface with a second cleaning solution. Illustratively, the first cleaning solution may be a low viscosity cleaning solution or a high viscosity cleaning solution. Illustratively, the second cleaning solution may be a low viscosity cleaning solution or a high viscosity cleaning solution. In some examples, the first cleaning solution is a high viscosity cleaning solution and the second cleaning solution is a low viscosity cleaning solution

In some embodiments, the step of heating 130 the cleaning solution to a cleaning temperature may also include heating the surface of the device if the surface of the device is submerged in the cleaning solution. In some embodiments, the cleaning temperature may be between about 75° F. and about 250° F. The cleaning temperature may be one of several different temperatures depending on the surfactants in the cleaning solution. The cleaning temperature of the cleaning solution may be one of the following values: about 75° F., about 80° F., about 85° F., about 90° F., about 95° F., about 100° F., about 105° F., about 110° F., about 115° F., about 116° F., about 117° F., about 118° F., about 119° F., about 120° F., about 121° F., about 122° F., about 123° F., about 124° F., about 125° F., about 130° F., about 135° F., about 140° F., about 145° F., about 150° F., about 160° F., about 170° F., about 180° F., about 190° F., about 200° F., about 210° F., about 230° F., and about 250° F. It is within the scope of the present disclosure for the cleaning temperature of the cleaning solution to fall within one of many ranges. In a set of ranges, the cleaning temperature of the cleaning solution is one of the following ranges: about 75° F. to about 250° F., about 75° F. to about 200° F., about 75° F. to about 170° F., about 90° F. to about 170° F., about 100° F. to about 170° F., about 100° F. to about 150° F., about 100° F. to about 140° F., and about 100° F. to about 130° F.

In some embodiments, the step of sonicating 140 the cleaning solution and the surface of the device is performed for a fixed time. In some embodiments, the step of sonicating is performed up to about 2 hours. In some embodiments, the step of sonicating is performed up to about 1.5 hours. In some embodiments, the step of sonicating is performed for less than about 1 hour. It is within the present disclosure for the sonicating time to fall within one of many ranges. In a set of ranges, the sonicating time is one of the following ranges: about 2 minutes to about 1.5 hours, about 10 minutes to about 1 hour, about 10 minutes to about 45 minutes, about 10 minutes to about 30 minutes, and about 15 minutes to about 30 minutes. In some examples, the sonicating time is about 20 minutes. In some examples, the step of sonicating is repeated.

In some embodiments, the method may further include a step of rinsing the surface of the device. In some embodiments, the step of rinsing is performed after the step of sonicating. In some embodiments, the step of rinsing includes rinsing the surface of the device with water.

In some embodiments, the method may further include exposing the surface of the electro-cautery probes to air. Illustratively, if the device is an electro-cautery probe exposure to air may assist in the re-passivation process of the metallic surface of the electro-cautery probe. In some embodiments, the step of exposing the cleaned surface of the device to air may be performed for 2 hours. In some embodiments, the step of exposing the cleaned surface of the device to air may be performed less than 1 hour. In some embodiments, the step of exposing the cleaned surface of the device to air may be performed for at least 5 minutes.

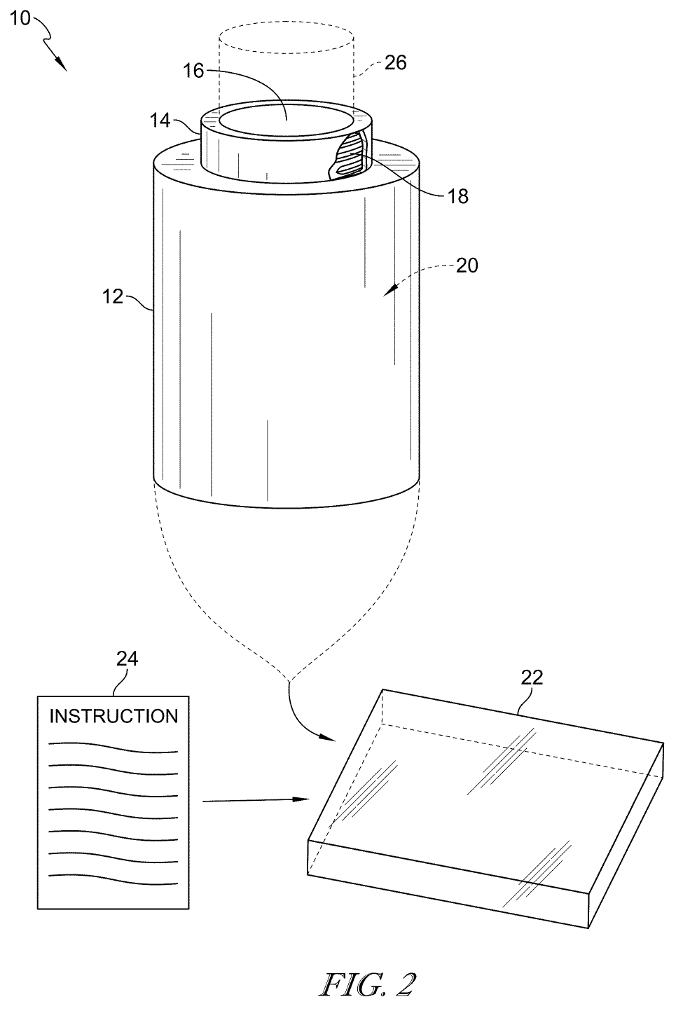

The cleaning solution in accordance with the present disclosure may be included in a kit 10 for cleaning surfaces, as shown in FIG. 2. In some embodiments, the kit 10 may include the cleaning solution in a container 12 and a set of instructions 24, both of which may be enclosed in a package 26. The cleaning solution may be stored in an interior product-storage region 20 of the container. The container 12 may be sized to receive the surface of the device. In some embodiments, the container may be sized to receive an electro-cautery probe. A lid 14 may be placed on the container 12 to block-selectively access to the interior product-storage region 20.

In some embodiments, the container 12 includes a brim 18, a floor, and a side wall, as suggested in FIG. 2. The brim 18 is located spaced-apart from the floor to locate the sidewall therebetween. The brim 18 is located along a top edge of the side wall and forms an aperture that opens into the interior product-storage region 20. The brim 18, the floor, and the side wall cooperate to form the interior product-storage region 20.

In some embodiments, the lid 14 is coupled to the brim 18. In some embodiments, the lid 14 comprises a film 16 configured to be punctured by a device. Illustratively, the film 16 may be an aluminum foil.

In some embodiments, the lid 14 may comprise a foam top 26, as suggested in FIG. 2. The foam top 26 may be in fluid communication with the interior product storage region 20 so that the cleaning solution may flow from the container and through the foam top 26.

In some embodiments, the kit may comprise small single-use bottles with dauber-tops, sponge-tops, spray-tops, self-sealing orifices for device insertion, tuohy-borst adapters, or a hollow brush that screws onto the top of the container 12 and allows the cleaner to be applied directly to the surface being cleaned through the brush itself.

In some embodiments, the kit may comprise a medical lubricant. Examples of medical lubricants can be found in U.S. Pat. No. 7,217,270 and U.S. Patent Application Publication No. 2017/0049938, each of which is hereby incorporated by reference in its entirety.

In some embodiments, the kid may include sponges, scrubber pads, or brushes to aid in cleaning.

### EXAMPLES

### Example 1

Cleaning Solution

A cleaning solution comprises H₂O₂. The amount of H₂O₂ is about 3% v/v.

### Example 2

Cleaning Solution

A cleaning solution comprises H₂O₂ and citric acid. The percentages by weight of the components were about:

| | |
|---|---|
| 3% | H₂O₂ |
| 2% | Citric Acid |

The components were combined with water via blending to form a cleaning solution.

### Example 3

Cleaning Solution

A cleaning solution comprises H₂O₂ and phosphoric acid. The percentages by weight of the components were about:

| | |
|---|---|
| 3% | H₂O₂ |
| 1% | Phosphoric Acid |

The components were combined with water via blending to form a cleaning solution.

### Example 4

Cleaning Solution

A cleaning solution comprises H₂O₂ and ascorbic acid. The percentages by weight of the components were about:

| | |
|---|---|
| 3% | H₂O₂ |
| 5% | Ascorbic acid |

The components were combined with water via blending to form a cleaning solution.

### Example 5

Cleaning Solution

A cleaning solution comprises H₂O₂ and citric acid. The percentages by weight of the components were about:

| | |
|---|---|
| 3% | H₂O₂ |
| 5% | Citric Acid |

The components were combined with water via blending to form a cleaning solution.

### Example 6

Cleaning Solution

A cleaning solution comprises about 1% w/v phosphoric acid in water.

### Example 7

Cleaning Solution

A cleaning solution comprises oxalic acid, polysorbate-80, Tergitol™ 15-S-3, Tergitol™ 15-S-7, and sodium lauryl sulfoacetate. The percentages by weight of the components were about:

| | |
|---|---|
| 1% | Oxalic Acid |
| 0.5% | Polysorbate-80 |
| 0.5% | Tergitol ™ 15-S-3 |
| 0.5% | Tergitol ™ 15-S-7 |
| 2% | Sodium Lauryl sulfoacetate |

The components were combined with water via blending to form a cleaning solution.

### Example 8

Cleaning Solution

A cleaning solution comprises oxalic acid, polysorbate-80, Tergitol™ 15-S-3, Tergitol™ 15-S-7, sodium lauryl sulfoacetate, H₂O₂, and ascorbic acid. The percentages by weight of the components were about:

| | |
|---|---|
| 1% | Oxalic Acid |
| 0.5% | Polysorbate-80 |
| 0.5% | Tergitol ™ 15-S-3 |
| 0.5% | Tergitol ™ 15-S-7 |
| 2% | Sodium Lauryl sulfoacetate |
| 3% | H₂O₂ |
| 1.5% | Ascorbic acid |

The components were combined with water via blending to form a cleaning solution.

### Example 9

Cleaning Solution

A cleaning solution comprises oxalic acid, polysorbate-80, Tergitol™ 15-S-3, Tergitol™ 15-S-7, sodium lauryl sulfoacetate, H₂O₂, and ascorbic acid. The percentages by weight of the components were about:

| | |
|---|---|
| 1% | Oxalic Acid |
| 0.5% | Polysorbate-80 |
| 0.5% | Tergitol ™ 15-S-3 |
| 0.5% | Tergitol ™ 15-S-7 |
| 2% | Sodium Lauryl sulfoacetate |
| 3% | H₂O₂ |
| 3.1% | Ascorbic acid |

The components were combined with water via blending to form a cleaning solution.

### Example 10

Cleaning Solution

A cleaning solution comprises oxalic acid, polysorbate-80, Tergitol™ 15-S-3, Tergitol™ 15-S-7, sodium lauryl sulfoacetate, H₂O₂, and ascorbic acid. The percentages by weight of the components were about:

| | |
|---|---|
| 1% | Oxalic Acid |
| 0.5% | Polysorbate-80 |
| 0.5% | Tergitol ™ 15-S-3 |
| 0.5% | Tergitol ™ 15-S-7 |
| 2% | Sodium Lauryl sulfoacetate |
| 3% | H₂O₂ |
| 0.75% | Ascorbic acid |

The components were combined with water via blending to form a cleaning solution.

### Example 11

Electro-Cautery Probe Charring

A set of monopolar electro-cautery probes were coated with Electro-Lube®, available from Mectra Labs, using a Q-tip applicator. The coated probes were charred by subjecting a small localized spot of a chicken breast to extensive coagulation-cautery. This procedure produced a relatively uniform heavy layer of brownish-black resin-like char on the probe that was largely devoid of actual tissue.

### Example 12

Electro-Cautery Probe Cleaning

An electro-cautery probe was covered in char as described in Example 11. The electro-cautery probe was added to a vesicle containing a cleaning solution selected from the cleaning solutions described in Examples 1-10. Cleaning cycles of 20 minutes at a bath temperature of about 120° F. were used for most testing. The electro-cautery probes were rinsed with water and exposed to air.

### Example 13

Electro-Cautery Probe Passivation Analysis

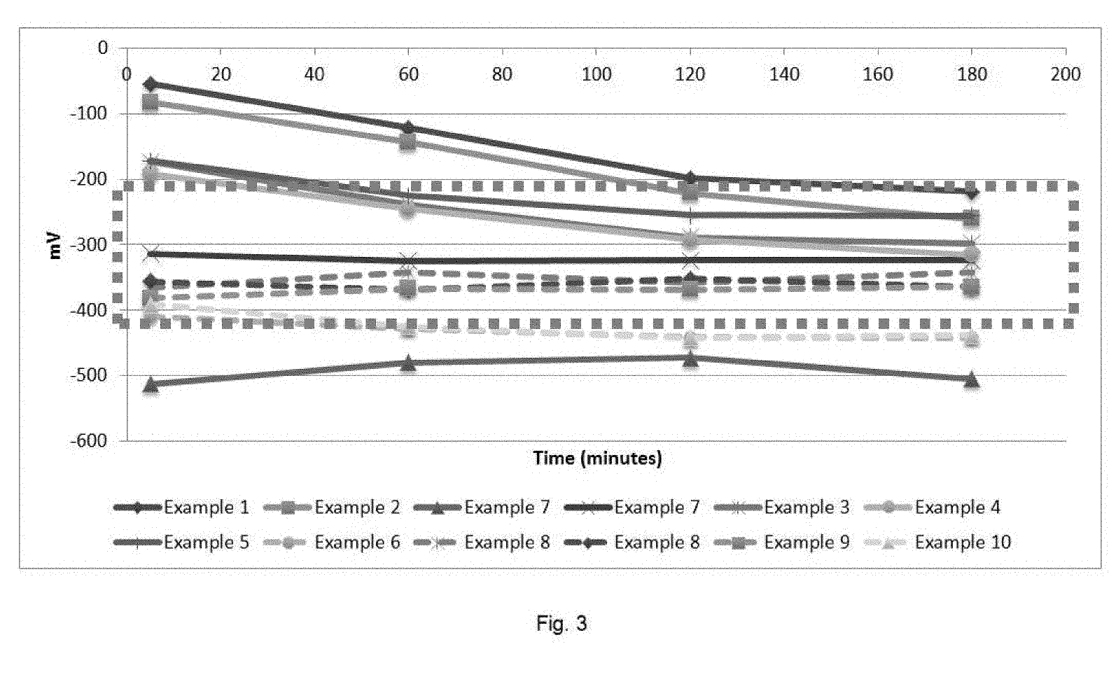

To test passivation, a passivation testing kit (Passi-Tester 2026®) was purchased from Koslow Scientific. Briefly, electro-cautery probes were cleaned with fresh distilled water and blown dry with a compressed air stream. The probes were then tested for baseline levels of passivation using the above-mentioned testing kit. Three measurements were taken from each probe from different locations on each probe and were averaged together to create an overall passivation score for that probe. The probes were placed in test-tubes of containing the cleaning solutions of Examples 1-10 and sonicated for 20 minutes at about 120° F. After sonicating, the probes were again rinsed with fresh distilled water, blown dry with compressed air, and tested for passivation using the above-detailed procedure. Results of the passivation analysis can be seen in FIG. 3. The electro-cautery probes cleaned with the cleaning solutions from Examples 7, 8, 9, and 10 achieved passivation in 20 minutes, whereas the electro-cautery probes cleaning with the cleaning solutions from Examples 1, 2, 3, 4, and 5 required 180 minutes, 165 minutes, 30 minutes, 15 minutes, and 30 minutes of time, respectively.

### Example 14

High Viscosity Cleaning Solution

A volume of water is brought up to 60° C. under stirring (about 200-300 RPM), and sodium lauryl sulfoacetate (SLSA) is added by sifting at a rate of 1.0-3.0%. Once this is fully dissolved, anhydrous oxalic acid is added at a rate of 1.0-10.0%, followed by PS-80 at a rate of 0.1-2.0%. After this solution has fully dispersed, the remaining surfactants are added, each at a rate of 0.2-1.0%. This solution remains under heat and stirring while in a separate container a volume of glycerin equal to 10.0-30.0% of the final solution volume is brought to 60° C. under moderate stirring. To this glycerin is added a quantity of xanthan gum equal to 0.25-2.0% of the total solution. The xanthan gum disperses in the glycerin quickly, and then is immediately added to the aqueous volume. After about 1-minute heating can be turned off, but stirring is continued until the solution thickens to a gelled consistency and takes on a white appearance.

### Example 15

High Viscosity Cleaning Solution

A cleaning solution comprises glycerin, xanthan gum, oxalic acid, polysorbate-80, Tergitol™ 15-S-3, Tergitol™ 15-S-7, and sodium lauryl sulfoacetate. The percentages by weight of the components were about:

| | |
|---|---|
| 25% | Glycerin |
| 1.25% | Xanthan gum |
| 2% | Sodium Lauryl Sulfoacetate |
| 3% | Oxalic acid |
| 0.3% | Tergitol ™ 15-S-3 |
| 0.3% | Tergitol ™ 15-S-7 |
| 0.3% | Polysorbate-80 |

The components were combined via blending as described in Example 14 to form a high viscosity cleaning solution.

### Example 16

High Viscosity Cleaning Solution

A cleaning solution comprises glycerin, xanthan gum, oxalic acid, polysorbate-80, Tergitol™ 15-S-3, Tergitol™ 15-S-7, and sodium lauryl sulfoacetate. The percentages by weight of the components were about:

| | |
|---|---|
| 10% | Glycerin |
| 2% | Xanthan gum |
| 2% | Sodium Lauryl Sulfoacetate |
| 3% | Oxalic acid |
| 0.3% | Tergitol ™ 15-S-3 |
| 0.3% | Tergitol ™ 15-S-7 |
| 0.3% | Polysorbate-80 |

The components were combined via blending as described in Example 14 to form a high viscosity cleaning solution.

### Example 17

Two Step Method

An exemplary two-step method for using a high viscosity cleaning solution and a low viscosity cleaning solution is as follows.

Directly after the using the device in an operation in the operating room, the dirty working-end of the device can be coated with the high viscosity cleaning solution according to Example 16 or 17, for example. Application can occur most efficiently by immersing the device in the high viscosity cleaning solution, preferably by inserting the device into the opening of a single-use bottle. This allows the high viscosity cleaning solution to completely conform to the contours of the device and fill any cavities or voids that may be missed by wiping the high viscosity cleaning solution onto the device. After submerging the device in the high viscosity cleaning solution, the device can either be extracted from the bottle and placed aside for transport to the cleaning facility or left inserted in the bottle during transport to contain the possible spread of contaminated high viscosity cleaning solution on other surfaces or personnel. Application of the high viscosity cleaning solution in the operating room allows the cleaning process to begin immediately while the residue is still “fresh” and has not dried, further adhering itself to the probe, and also improves the efficiency of labor, as cleaning is actively occurring prior to, and during, transport from the OR to the cleaning facilities.

Once the device has made it to the cleaning facility, treating the device with a low viscosity cleaning solution in an ultrasonic cleaner in a temperature range of 100° F.-150° F. for 10-20 minutes. The high viscosity cleaning solution does not need to be removed and will dissolve into the low viscosity cleaning solution as cleaning progresses. Use in an ultrasonic cleaner can occur in an enclosed container to reduce the volume of low viscosity cleaning solution required.

Alternatively, if use in an ultrasonic is not desired or feasible, the devices can be left to soak in a container of the low viscosity cleaning solution. While doing so at room temperature is still effective, raising the temperature of the cleaning solution to about 110° F. could improve results. Instruments can be left to soak for 10-20 minutes.

After being removed from the ultrasonic cleaner or soaking container, the probes may need a gentle scrubbing to remove the loosened detritus. This can be accomplished using a plastic bristle-brush such as a toothbrush or similar tool. To improve the results of scrubbing with a brush, the brush may be dipped-in or saturated-with the low viscosity cleaning solution.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A cleaning solution comprising
an organic acid comprising a compound of the formula 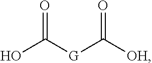
or a salt thereof, wherein G is selected from the group consisting of a bond, C₁₋₁₀ alkylene, C₂₋₁₀ alkenylene, C₂₋₁₀ alkynylene, C₁₋₁₀ heteroalkylene, C₂₋₁₀ heteroalkenylene, and C₂₋₁₀ heteroalkynylene, and wherein each hydrogen atom in C₁₋₁₀ alkylene, C₂₋₁₀ alkenylene, C₂₋₁₀ alkynylene, C₁₋₁₀ heteroalkylene, C₂₋₁₀ heteroalkenylene, and C₂₋₁₀ heteroalkynylene may be optionally substituted with one or more R^{N}, wherein each R^{N} is independently selected from the group consisting of—halo, oxo, —OH, —CN, —NO₂, —CF₃, —OCF₃, —CO₂H, and —NH₂, and
a surfactant blend comprising a primary surfactant and a first co-surfactant.

2. The cleaning solution of claim 1, wherein G is a bond or —CH₂C(OH)(CO₂H)CH₂—.

3. The cleaning solution of claim 2, wherein the primary surfactant comprises a compound having the formula 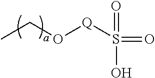
or a salt thereof, wherein a is an integer from 1-20, and Q is a bond or —C(O)CH₂—.

4. The cleaning solution of claim 3, wherein a is 11 and Q is a bond.

5. The cleaning solution of claim 4, wherein the first co-surfactant comprises a compound having the formula 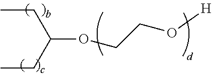
or a salt thereof, wherein each of b and c is independently an integer from 0 to 12, and d is an integer from 3 to 40.

6. The cleaning solution of claim 5, wherein d is 3 and the sum of b+c is 8 to 14.

7. The cleaning solution of claim 5, wherein d is 7 or 9 and the sum of b+c is 8 to 14.

8. The cleaning solution of claim 1, wherein the primary surfactant has a Hydrophile-Lipophile Balance (HLB) of at least about 15.

9. The cleaning solution of claim 8, wherein the first co-surfactant has an HLB selected from a range of about 12 to about 16.

10. The cleaning solution of claim 1, wherein the cleaning solution has a viscosity of at least 40,000 cps.

11. A cleaning solution comprising
an organic acid, and
a surfactant blend comprising a primary surfactant having a Hydrophile-Lipophile Balance (HLB) of at least about 15, a first co-surfactant having an HLB selected from a range of about 12 to about 16, a second co-surfactant having an HLB selected from a range of about 6 to about 10, and an emulsifier.

12. The cleaning solution of claim 11, wherein the HLB of the primary surfactant is in a range of about 20 to about 45.

13. The cleaning solution of claim 12, wherein the primary surfactant comprises a compound having the formula 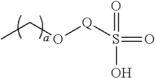
or a salt thereof, wherein a is an integer from 1-20, and Q is a bond or —C(O)CH₂—.

14. The cleaning solution of claim 11, wherein the first co-surfactant comprises a compound having the formula 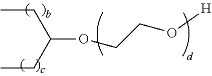
or a salt thereof, wherein the sum of b+c is 8 to 14, and d is 7 or 9.

15. The cleaning solution of claim 14, wherein the second co-surfactant comprises a compound having the formula 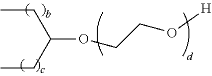
or a salt thereof, wherein the sum of b+c is 8 to 14, and d is 3.

16. The cleaning solution of claim 15, wherein the emulsifier comprises a compound having the formula 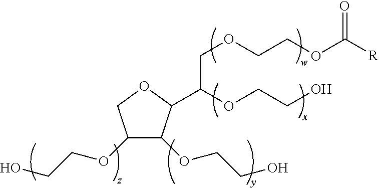
or a salt thereof, wherein each of w, x, y, and z is respectively an integer from 1-20, the sum of w, x, y, and z is a multiple of 20; and R is selected from the group consisting of C₁₀₋₂₀ alkyl, C₁₋₁₀ alkyl, C₁₀₋₂₀ alkenyl, C₂₋₁₀ alkenyl, C₁₀₋₂₀ alkynyl, C₂₋₁₀ alkynyl, C₁₀₋₂₀ heteroalkyl, C₁₋₁₀ heteroalkyl, C_{10-°}heteroalkenyl, C₂₋₁₀ heteroalkenyl, C_{10-°}heteroalkynyl, and C₂₋₁₀ heteroalkynyl, and wherein each hydrogen atom in C_{10-°}alkyl, C₁₋₁₀ alkyl, C₁₀₋₂₀ alkenyl, C₂₋₁₀ alkenyl, C₁₀₋₂₀ alkynyl, C₂₋₁₀ alkynyl, C₁₀₋₂₀ heteroalkyl, C₁₋₁₀ heteroalkyl, C₁₀₋₂₀ heteroalkenyl, C₂₋₁₀ heteroalkenyl, C₁₀₋₂₀ heteroalkynyl, and C₂₋₁₀ heteroalkynyl may be optionally substituted with one or more R^{M}, and wherein each R^{M} is independently selected from the group consisting of—halo, oxo, —OH, —CN, —NO₂, —CF₃, —OCF₃, —CO₂H, and —NH₂.

17. A method of cleaning a device, the method comprising
contacting the device with a first cleaning solution comprising a first organic acid and a first surfactant blend,
wherein the first organic acid comprises a compound of the formula 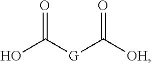
or a salt thereof, wherein G is selected from the group consisting of a bond, C₁₋₁₀ alkylene, C₂₋ alkenylene, C₂₋ alkynylene, C₁₋₁₀ heteroalkylene, C₂₋₁₀ heteroalkenylene, and C₂₋₁₀ heteroalkynylene, and wherein each hydrogen atom in C₁₋₁₀ alkylene, C₂₋₁₀ alkenylene, C₂₋₁₀ alkynylene, C₁₋₁₀ heteroalkylene, C₂₋₁₀ heteroalkenylene, and C₂₋₁₀ heteroalkynylene may be optionally substituted with one or more R^{N}, wherein each R^{N} is independently selected from the group consisting of—halo, oxo, —OH, —CN, —NO₂, —CF₃, —OCF₃, —CO₂H, and —NH₂, and the first surfactant blend comprises a first primary surfactant and a first co-surfactant,
wherein the first cleaning solution has a viscosity less than about 10,000 cps.

18. The method of claim 17, wherein the method further comprises contacting the device with a second cleaning solution, wherein the second cleaning solution comprises a second organic acid, a second surfactant blend, and a thickening agent,
wherein the second organic acid comprises a compound of the formula 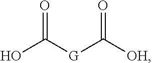
or a salt thereof, wherein G is selected from the group consisting of a bond, C₁₋₁₀ alkylene, C₂₋₁₀ alkenylene, C₂₋₁₀ alkynylene, C₁₋₁₀ heteroalkylene, C₂₋₁₀ heteroalkenylene, and C₂₋₁₀ heteroalkynylene, and wherein each hydrogen atom in C₁₋₁₀ alkylene, C₂₋₁₀ alkenylene, C₂₋ alkynylene, C₁₋₁₀ heteroalkylene, C₂₋₁₀ heteroalkenylene, and C₂₋₁₀ heteroalkynylene may be optionally substituted with one or more R^{N}, wherein each R^{N} is independently selected from the group consisting of—halo, oxo, —OH, —CN, —NO₂, —CF₃, —OCF₃, —CO₂H, and —NH₂,
the second surfactant blend comprises a second primary surfactant and a second co-surfactant, and
the second cleaning solution has a viscosity greater than about 40,000 cps.

19. The method of claim 18, wherein the device is contacted with the second cleaning solution prior to contacting the device with the first cleaning solution.

20. The method of claim 18, wherein the first organic acid is substantially the same as the second organic acid and the first primary surfactant is substantially the same as the second primary surfactant.
